(19) United States
(12) Patent Application Publication
(10) Pub. No.: US 2011/0217892 A1
(43) Pub. Date: Sep. 8, 2011

(54) FABRIC, A DEVICE WITH FABRIC AND A MANUFACTURING METHOD FOR FABRIC

(75) Inventors: Peter Chabrecek, Freidorf (CH); Hanspeter Meier, Schachen (CH)

(73) Assignee: SEFAR AG, Thal (CH)

(21) Appl. No.: 13/128,974

(22) PCT Filed: Nov. 11, 2009
(86) PCT No.: PCT/EP09/08038

§ 371 Date: May 12, 2011

(30) Foreign Application Priority Data
Nov. 13, 2008 (DE) 10 2008 057 303.5
Jul. 15, 2009 (DE) 10 2009 033 510.2

(51) Int. Cl. B29C 70/22; B32B 5/02

(52) U.S. Cl. 442/60; 28/169; 442/110

(57) ABSTRACT

A woven fabric (1) made from threads (2) that are formed from plastic at least one their outside surface. At least one surface side (7) of the fabric (1) is partially metallically coated.

### BACKGROUND OF THE INVENTION

The invention concerns a fabric that is woven from threads that at least on their outer surface are formed from plastic. Furthermore the invention concerns a device with at least one fabric of this type, the use of such a fabric for different applications, and a method for the manufacture of a fabric.

In practice for large-scale applications screen printing fabrics are today woven from plastic threads, mostly of PET or PA. The screen printing fabrics of known art become statically charged during handling, in particular during manufacture, or when they are being attached, in particular with an adhesive, onto screen printing frames, and also in the actual screen printing process. The static charge is particularly intense when the fabric is being unwound from a roller, during a process of attaching the screen printing fabric with adhesive and coating of the same, as well as when using a squeegee in the course of the printing process, as a result of the frictional contact between the squeegee and the screen printing fabric. In practice the static charge leads to serious problems. Thus it makes the handling of the screen printing fabric more difficult, since as a result of the static charge the screen printing fabric moves towards objects, and operators and remains “stuck” there. Furthermore, there is the problem that statically charged screen printing fabrics attract dirt and dust particles from the environment, as a result of which the quality of the screens deteriorates, since during the application of a light-sensitive emulsion the dust and dirt are incorporated into it, leading to a deterioration of the resultant exposure and to clogged-up openings in the mesh. In addition the resultant print can deteriorate severely if dust and dirt particles disrupt the optimal flow of color, or settle together with the color onto the item that is being printed. Furthermore it has been observed that a static charge deteriorates the flow of color and the color release characteristics, in particular of metallic colors, or colors that can be attracted by charge.

Furthermore it is of known art to deploy plastic fabrics in screening machines as screening fabrics. In particular when screening flour any addition of coarse particles into the product falling through the screen is to be avoided, so that any cracks or fractures in screening fabrics of plastic caused by wear must be detected at an early stage.

In DE-OS-1 648 368 a method for contact-free and non-destructive measurement of screen abrasion has therefore been proposed. Here radiation is directed onto the screening fabric, and the reflected component is measured. The measured value should thereby be a function of the residual thickness of the screen. When a limiting value is reached an appropriate warning signal should be triggered.

From DE-A-43 240 66 a screening fabric of plastic threads is of known art, wherein additional electrically conductive threads of carbon fibers are woven into the fabric, running in one direction. Fault monitoring should be reliably enabled by means of a conductivity measurement.

From DE-U-67 513 32 and DE-OS 23 263 06 it is of known art to apply a full metallic coating to a plastic fabric so as to increase the strength and stiffness by this means. DE-C-32 270 20 discloses the adhesive bonding of insulated threads onto a screen, DE-A-24 435 48 the introduction of electrical monitoring threads into material webs, and from DE-A-43 240 66 it is of known art that threads of this type can lead to a hardening of the fabric and thus to an increased susceptibility to fracture.

DE 197 38 872 A1 describes a fabric for deployment as a screen printing template, wherein a coating layer is vapor-deposited onto the fabric and the fabric is subsequently mechanically coated. By means of this measure the printing result is improved.

DE 103 38 029 A1 describes a fabric for items of clothing, and an item of clothing made of a fabric of this type. The fabric features two electrically conducting threads, each of which is surrounded by insulation material and connected to a central unit that monitors an electrical property of the fabric, so as to be able to detect any damage to the fabric by this means.

### SUMMARY OF THE INVENTION

With the above-cited prior art as a starting point the object of the invention is to propose an alternative fabric. The fabric is to be suitable for a large number of different applications. Most particularly preferred is the provision of an electrical conductivity without the necessity of inserting already metallized threads or solid metal threads into the weave of the fabric. Furthermore the object consists in specifying a device with a fabric of this type and also a manufacturing method for a fabric of this type.

In a fabric of the generic kind the object is achieved in that at least one surface side of the fabric is partially metallically coated. Preferably no further coating designed as an electrical conductor is located outboard of the metallic coating.

With regard to the device the object is achieved by the deployment of at least one fabric designed in accordance with the concept of the invention.

With regard to the method the object is achieved by means of the following steps:
provision of a fabric that is woven from threads formed at least on their outer surface from plastic, and
generation of a partial metallic coating on at least one surface side of the fabric.

Advantageous further embodiments of the invention are specified in the dependent claims. Within the framework of the invention all combinations comprise at least two of the features disclosed in the description, the claims and/or the figures. To avoid repetitions, features disclosed in accordance with the method are deemed to apply as disclosed and claimable in accordance with the device. Likewise features disclosed in accordance with the device are deemed to apply as disclosed and claimable in accordance with the method.

The concept underlying the invention is the provision of the fabric manufactured from plastic threads preferably formed from solid material, in particular PET or PA threads, after the weaving process with an exclusively partial, i.e. not over the full surface area, electrically conducting coating. Expressed in another manner, by the coating of the fabric, preferably consisting exclusively of plastic, at least one electrical conductor (a flat conductor) is implemented. Thus a printed circuit, in particular a flexible printed circuit, is created on a fabric base, which can be used for a very wide variety of purposes. Expressed in yet another manner, at least one electrical conductor, preferably in the form of a resistance labyrinth or in the form of a conducting path network, is implemented by means of a metallic coating, and not by means of the threads themselves. In principle it is possible to insert into the fabric at least one conductor that is metallic on its outer surface, wherein a form of embodiment is preferred in which the fabric consists exclusively of threads which on their outer surfaces are formed from plastic, and still more preferably consist of solid plastic material. If the fabric designed in accordance with the concept of the invention is deployed as a screen printing fabric, the conductors manufactured by means of coating can then be used for the dissipation of static charge, in other words, for earthing the screen printing fabric to prevent the screen printing fabric from “sticking” to objects. In addition by means of this measure the attraction of dirt and dust particles is avoided. Here it is most particularly preferred if the screen printing fabric is earthed by means of partially metallic frames, in particular of aluminum, wherein direct contact between the screen printing fabric and an earthing cable is also conceivable.

The fabric designed in accordance with the concept of the invention is, however, not limited to the above-described screen printing applications. Thus it is, for example, conceivable to deploy the fabric as a screening fabric in a screening machine, and to connect the at least one, preferably exclusively one, conductor, in particular designed as a resistance labyrinth by means of coating, in an electrically conducting manner with a monitoring device, in particular a continuity testing unit, so as to monitor the screening fabric for damage.

Further applications of the fabric, in particular as a component of a sensor, or as an electrode, or as an electrical circuit, or as a reflective layer, or as an optically partially transparent layer, or as an electrically conducting adhesive layer, or as a heating element, or as a component of a lighting device, or as a printed circuit, in particular a flexible printed circuit, or as an antenna, in particular for RFID applications, or as a component of a solar cell, or as a component of a fuel cell, or as a component of a plasma display, or as a component of a liquid crystal display, or as a component of an OLED, or as a component of a flexible display, or as a component of an organic thin-film transistor, are alternatively conceivable. Further regions of deployment are possible.

With regard to the arrangement of the coating there are various possibilities. Thus for the function of the coating as a means of charge dissipation it is in principle sufficient to provide the coating on just one surface side of the screen printing fabric. Also it is conceivable to apply the coating on both sides in order to circumvent the risk of an incorrect installation. Most particularly preferred is the application of conducting paths on only one side so as to avoid short circuits between different conducting paths on different sides of the fabric.

In principle, the partial metallic coating can consist of a single metal layer. Alternatively a multi-layer structure (hybrid coating) is also conceivable, wherein at least one of the layers, preferably all the layers, is/are formed as a metal layer. It is particularly preferred if the outermost layer of a multi-layer coating is formed from a chemically-resistant material, in particular chromium, in particular if the fabric is then deployed for screen printing applications. The outermost layer should thereby be formed such that it is resistant to aggressive solvents, removal of coatings, removal of colors, colors and/or cleaning agents. It is further preferred if a cost-effective metal layer, in particular of aluminum, or an aluminum alloy, copper, or a copper alloy is provided underneath the outermost layer, preferably as a base layer. If necessary at least one layer or a transition between two layers can be formed as a gradient layer.

As stated in the introduction, it is preferred if the partial metallic coating is designed as a conducting path structure, wherein one or a plurality of conducting paths are implemented, separated from one another, or connected with one another, or connectable with one another. It is particularly preferred if a branched conducting path is provided for complex applications. Also it is conceivable for a labyrinthine design of the conducting path to be implemented, which winds across, at least approximately, the whole extent of the surface area, so as to be able to monitor the fabric for damage.

To implement a fabric damage monitoring function the at least one, preferably exclusively one, conducting path preferably makes contact with a monitoring device. It is most particularly preferred if the at least one conducting path makes contact with an electrical and/or electronic component, preferably arranged on the fabric, connected, for example by means of reflow soldering.

The coating preferably comprises at least one of the metals of the group: silver, copper, aluminum, nickel, molybdenum, gold, titanium, or chromium, or is formed from one such metal. Also it is conceivable that the coating comprises an alloy of at least one such metal, or is formed from an alloy, comprising at least one of these metals. In principle other metals can also be deployed.

As already indicated in the introduction, the fabric can comprise threads formed from a solid metal, and/or threads with a metallic core, or with a metallic coating. It is most particularly preferred, however, if the fabric is woven exclusively from threads consisting of a polymer material, in particular PET or PA.

It is especially preferred if the coating thickness is selected to be just as thick as is absolutely necessary for the relevant application. By the implementation of a minimal coating thickness in the case of deployment of the fabric as a screen printing fabric negative influences on the printing result can be prevented. If the coating is serving the purpose of charge dissipation it is most particularly preferred, in particular, if the thickness of the one or multi-layered coating is selected from a range of values between about 10 nm and about 1000 nm. It is most particularly preferred if the coating thickness lies in a range between about 20 nm and about 500 nm. It is further preferred if the diameter of the plastic threads before coating is selected from a range of values between about 10 μm and about 1000 μm, preferably between about 24 μm and about 200 μm.

It is most particularly preferred if the fabric is woven as a taffeta fabric or as a twill fabric. It is most particularly preferred if the fabric takes the form of a monofilament fabric, which is preferably woven exclusively from monofilaments.

As already commented the fabric in accordance with the invention is not only suitable for deployment as a screen printing fabric, but can, for example, also be deployed as a filter fabric or as a screening fabric, wherein it is further preferred if such a fabric is connected with a monitoring device for purposes of monitoring the fabric for damage, in particular the formation of fractures or cracks. This preferably uses the electrical conductivity of the electrical coating, preferably applied in a linear manner, in particular, in the form of a labyrinth. A particularly preferred option for the design of the monitoring device consists in designing the latter as a electrical continuity testing unit known per se, preferably on the basis of a resistance measuring device, which in the event of detection of damage outputs, for example, a warning signal, or a control signal (in particular a stop signal) to a device, in particular a printing device, a clamping device, or a screening machine, etc.

In the case of the design of the monitoring device as a continuity testing unit, it is preferable to connect the monitoring device with two ends of the coating applied in the form of a pattern, preferably as a type of linear conductor, which are separated from one another.

The invention also features a device, comprising at least one fabric designed in accordance with the concept of the invention. The device can, for example, take the form of a screen printing device, or a screening device (screening machine). The device can be designed as a sensor, or can comprise a sensor, or as a cable, or can comprise a cable, or as a heating device, or as a lighting device, or as a printed circuit, in particular a flexible printed circuit, or as a solar cell, or as a fuel cell, or as a display, in particular a flexible display, or as an OLED, or as a transistor, or as an electronic component, etc.

The invention also features a method for the manufacture of a fabric designed as previously described. In its general form the method is identified by the steps:
provision of a fabric that is woven from threads formed at least on their outer surface from plastic, and
generation of a partial metallic coating on at least one surface side of the fabric.

The partial metallic coating, in other words, the manufacture of at least one conducting path, to each side of which no coating is preferably provided, at least no electrically conducting coating, can take place in a very wide variety of ways. Thus it is conceivable to apply a coating specifically in particular regions only, alternatively to apply initially a full surface area coating, and then in a subsequent step to remove this metallic coating once again in the regions in which no metallic coating is to be provided.

A first option for the generation of the partial mechanical coating consists in the fabric being firstly provided with a mask (a mask coating). Expressed in another way a protective layer, in particular a protective lacquer, for example, a polymer, is firstly partially provided, i.e. the fabric is partially covered with such a protective layer, which prevents the adhesion of the electrically conductive coating to the fabric. After the subsequent, preferably full surface area, application of the metallic coating, in particular by means of sputtering, vapor deposition or a galvanic method, the protective layer, together with the metal applied thereon, can be removed, preferably washed off, after the moralization process.

With regard to the manner of the application of the mask, i.e. of the, preferably at least initially fluid, masking material, there are various options. Thus the mask can, for example, be applied by means of screen printing or ink jet printing, and can, in fact, be applied preferably exclusively in the regions in which the metallic coating is not to adhere. The fabric is therefore partially provided with a mask.

The masking material is preferably water-soluble, so that the mask, together with the metal located on the mask, can be removed by means of steam and/or water, preferably by means of a steam jet and/or a water jet. The fabric is preferably dried in a subsequent step, in particular by means of the impingement of air, in particular the impingement of hot air.

An alternative option for the generation of the partial coating consists in the fabric being metallically coated, preferably over the full surface area, for example by means of sputtering, galvanically, chemically (i.e. without any current), or by vapor deposition, and in the coating subsequently being partially removed in the regions in which no metallic coating is to be provided. Etching agents are deployed such as, for example, an acid, in particular in the form of a paste or a solution, or as an ink, wherein the etching agent can be applied, for example, in the screen printing or ink jet printing method.

In the above cited chemical coating silver salts are reduced.

After a reaction time specific to the etching agent, in particular between some 5 and 30 minutes, in particular between 10 and 20 minutes, the etching agent is removed together with the regions of the, preferably chemically modified, in particular, oxidized coating, for example by means of water and/or steam, in particular by means of a water jet and/or a steam jet, wherein it is further preferred to dry the fabric, now provided with a electric circuit.

A further alternative for the generation of the partial metallic coating consists in the coating, after a preferably full surface area coating of the fabric with at least one metal, being partially removed once again with high energy radiation, in particular by means of laser irradiation.

### BRIEF DESCRIPTION OF THE DRAWINGS

Further advantages, features, and details of the invention ensue from the following description of preferred examples of embodiment and also from the drawings.

In these:

FIG. 1: shows a first method step for the generation of a partial mechanical coating, wherein a mask is applied with a masking material by means of printing in regions that in the finished fabric are not to be coated,

FIG. 2: shows the fabric coated with the mask after a drying process, whereupon the fabric provided with the mask is metallized over its full surface area,

FIG. 3: shows a further method step in which the masking with the metal coating is removed, and

FIG. 4: shows a partially metallized fabric and a metallized fabric designed as a screen printing fabric, which together with a screen printing frame forms a screen printing device or screen printing arrangement, which is earthed via the frame, or alternatively directly via the conducting path of the fabric,

FIG. 5: shows a method step of an alternative method for the generation of the partial metal coating, wherein a full surface area metallized fabric is partially coated with an etching agent,

FIG. 6: shows a further method step of the above-cited method, in which the etching agent is removed together with the chemically modified metal,

FIG. 7: shows a partially metallically coated fabric web as a result of the above described method,

FIG. 8: shows a method step of an alternative manufacturing method, in which a full surface area coated fabric is partially treated by means of a laser beam so as partially to remove the metal coating, and to retain the partial metal coating.

### DETAILED DESCRIPTION

In the figures the same elements, and elements with the same function, are identified the same reference symbols.

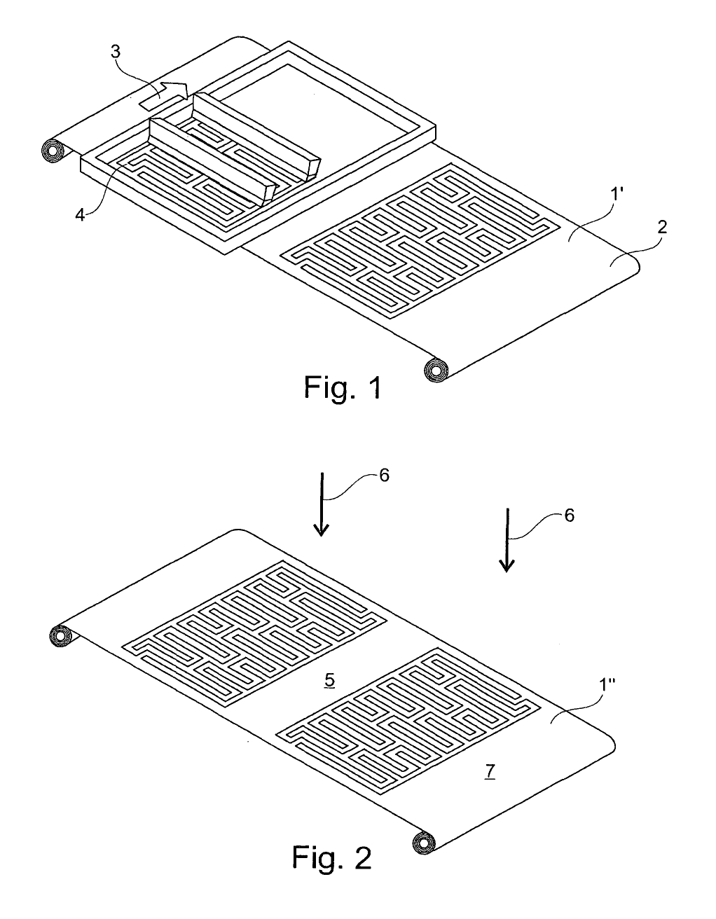

In FIG. 1 is shown a method step of a possible manufacturing method for the manufacture of a partially metallically coated fabric 1 shown in FIG. 4 above.

In the method an uncoated fabric 1′ is firstly provided as a fabric web. This uncoated fabric 1′ comprises, preferably consists of, threads 2 (weft threads and warp threads), which at least on their outer surface are formed from a polymer material (plastic).

FIG. 1 schematically represents the application (here by squeegee) of a mask 4, i.e. a masking material, in a printing direction 3 running transverse to the longitudinal extent of the fabric web, here by means of a screen printing method (alternatively, for example, by an ink jet printing method) in regions, which in the finished, partially coated fabric 1 (cf. FIG. 4) are not coated, or at least are not metallically coated.

In a method step following the above-described method step, the mask 4 is dried, for example by means of ventilation, and/or in a drying oven, whereupon the method step shown in FIG. 2 follows, in which a moralization, i.e. a metallic coating 5, is applied over the full surface area, as symbolized by the arrows 6. The application of the metallic layer—here only on one surface side 7—can take place, for example, by means of vapor deposition or sputtering. A full surface area coated fabric 1″ is obtained.

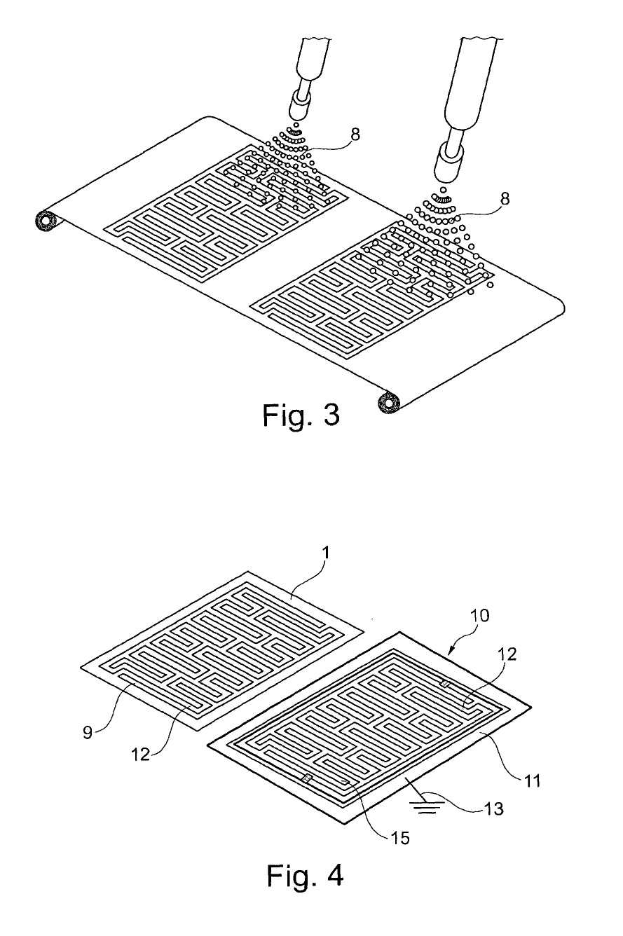

After the metallization step there follows the cleaning step shown in FIG. 3, in which the mask 4 with the metallic coating located on it is removed by means of a water and/or steam jet 8 from the plastic fabric.

Then follows a drying step, not represented, and the partially coated fabric represented in the upper part of FIG. 4 is obtained. The partial metallic coating 9 can be discerned, designed as a conducting path structure, which can make electrical contact, in particular with at least one electronic component, for example by means of soldering, in particular reflow soldering.

In the lower part of FIG. 4 is shown a screen printing arrangement 10, comprising a metallic, in particular formed from aluminum, screen printing frame 11, and a partially coated, i.e. provided with a conducting path 12, fabric. The conducting path 12, i.e. the conducting path structure 12, is in electrical contact with the screen printing frame 11, wherein the latter is earthed (see reference symbol 13). Alternatively or additionally the conducting path structure 12 can be earthed directly.

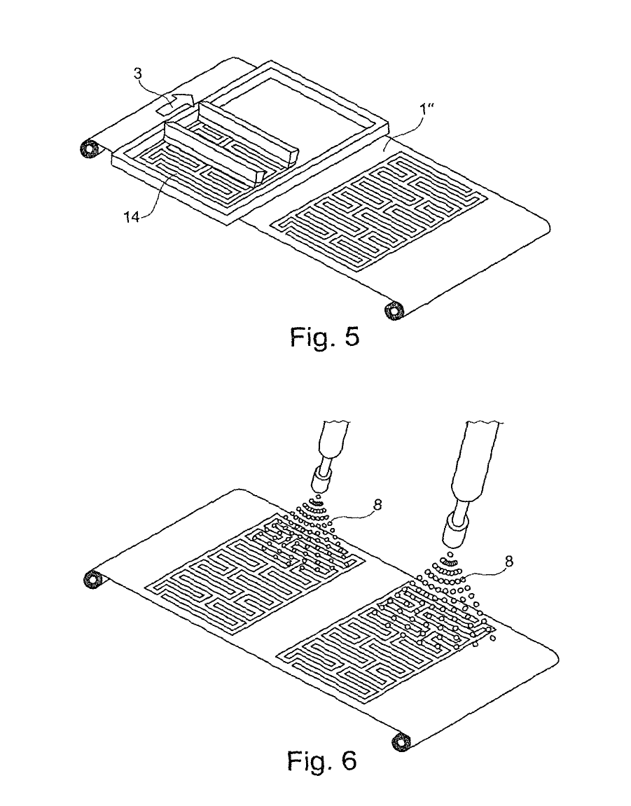

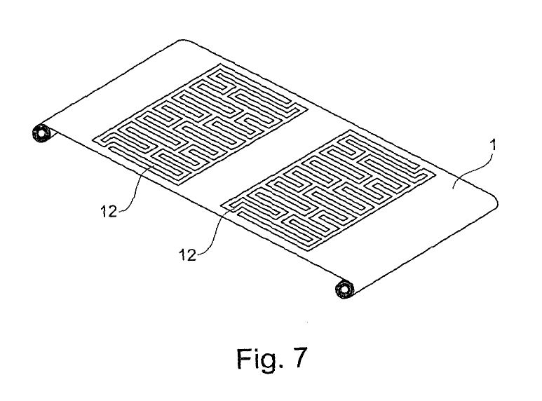

In FIG. 5 is shown a manufacturing step of an alternative manufacturing method. The method step shown in FIG. 5 was preceded by a metallization step, in which an initially uncoated fabric was metallically coated over its full surface area. In the following method step shown in FIG. 5 an etching agent 14 is applied onto the full surface area coated fabric 1″ in a printing direction 3 running transverse to the longitudinal extent of the fabric web by means of screen printing or alternatively, for example, ink jet printing; the etching agent attacks the moralization chemically in some regions and in the following method step shown in FIG. 6 the etching agent 14 together with the dissolved metal can be washed off by means of a steam jet and/or a water jet, so that the result is the partially coated fabric 1 shown in FIG. 7, still present in the form of a fabric web. The fabric 1 is distinguished by a conducting path structure 12 as well as by non-coated regions 15. These regions 15 are the regions in which the etching agent 14 was previously applied. The method step shown in FIG. 6 is followed by a drying step, in which the fabric 1 is washed.

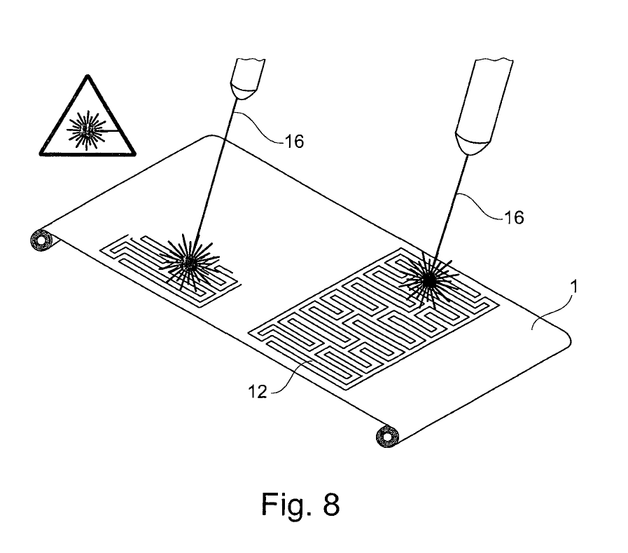

FIG. 8 shows a method step of a further alternative manufacturing method. The treatment step shown in FIG. 8 was preceded by a coating step, in which an initially uncoated fabric was provided with a metallization over its full surface area.

In FIG. 8 it can be discerned that a metallic coating is partially removed, so that a conducting path structure 12 is obtained. The removal takes place by means of high energy radiation 16, here by means of laser radiation.

1-22. (canceled)

23. A fabric, comprising woven threads having outer surfaces and surface sides wherein at least the outer surfaces are formed of plastic and at least one surface side of the fabric is partially metallically coated.

24. The fabric in accordance with claim 23, wherein the metallic coating forms a conducting path structure.

25. The fabric in accordance with claim 24, wherein the conducting path comprises a branched structure shaped in the form of a labyrinth.

26. The fabric in accordance with claim 25, wherein at least one electrical component is arranged on the fabric and comprises a monitoring device for monitoring the conducting path structure for damage.

27. The fabric in accordance with claim 23, wherein the metallic coating comprises a metal selected from the group consisting of silver, copper, aluminum, nickel, gold, titanium, chromium, and mixtures thereof.

28. The fabric in accordance with claim 23, wherein the threads are formed exclusively from a polymer material.

29. The fabric in accordance with claim 23, wherein the metallic coating has a thickness of between about 10 nm and about 1000 nm.

30. The fabric in accordance with claim 23, wherein the metallic coating has a thickness of between about 20 nm and about 500 nm.

31. The fabric in accordance with claim 23, wherein the threads have a diameter of between about 10 μm and about 1000 μm.

32. The fabric in accordance with claim 23, wherein the threads have a diameter of between about 24 μm and about 200 μm.

33. The fabric in accordance with claim 23, wherein the fabric is designed as one of a taffeta fabric and a twill fabric.

34. The fabric in accordance with claim 23, wherein the fabric comprises one of a screen printing fabric, a filter fabric, and a screening fabric.

35. A device comprising at least one fabric, wherein the fabric comprises woven threads having outer surfaces and surface sides wherein at least the outer surfaces are formed of plastic and at least one surface side of the fabric is partially metallically coated.

36. The device in accordance with claim 35, wherein the device comprises one of a screen printing device, a screening device, a sensor, a cable, a heating device, a lighting device, a flexible printed circuit, a solar cell, a fuel cell, a flexible display, an OLED, a transistor, and an electronic component.

37. A method for the manufacture of a fabric comprising the following steps:
providing threads having an outer surface of plastic;
forming a fabric from the threads; and
generating a partial metallic coating on at least one surface side of the fabric.

38. The method in accordance with claim 37, wherein, for generating the partial metallic coating, a mask is firstly applied onto the fabric, the fabric with mask is then coated by one of sputtering and vapor deposition, and the mask with the coating is removed.

39. The method in accordance with claim 38, wherein the mask is applied by one of screen printing and ink jet printing.

40. The method in accordance with claim 39, wherein the mask is water-soluble.

41. The method in accordance with claim 38, wherein the mask is removed with at least one of a high-pressure steam jet and a high-pressure water jet.

42. The method in accordance with claim 37, wherein for generating the partial metallic coating the fabric is firstly metallically coated over its full surface area by one of sputtering, galvanically, chemically, and vapor deposition.

43. The method in accordance with claim 37, wherein an etching agent is applied onto the metallic coating in regions that are later to be free of coatings.

44. The method in accordance with claim 43, wherein, after a reaction time of about 5 minutes to about 30 minutes with the etching agent, the regions of the coating are oxidized.

45. The method in accordance with claim 42, wherein the metallic coating is partially removed with high energy radiation.
